(19) United States
(12) Patent Application Publication
(10) Pub. No.: US 2024/0002556 A1
(43) Pub. Date: Jan. 4, 2024

(54) HIGH WEAR-RESISTANT GRAPHENE-MODIFIED NATURAL RUBBER AND PREPARATION THEREOF

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (TW); Shaofeng ZHOU, Taiyuan (TW); Guizhe ZHAO, Taiyuan (TW)

(21) Appl. No.: 18/060,657

(22) Filed: Dec. 1, 2022

(30) Foreign Application Priority Data
Jun. 16, 2022 (CN) 202210682912.6

(51) Int. Cl. C08F 36/08; C08K 3/04; C08K 3/22; C08K 5/09; C08K 5/3465; C08K 5/18; C08K 3/06; C08K 9/04; C08K 5/44; C08F 36/06; C08K 5/14; C08J 3/22

(52) U.S. Cl. CPC C08F 36/08; C08K 3/042; C08K 3/22; C08K 5/09; C08K 5/3465; C08K 5/18; C08K 3/06; C08K 9/04; C08K 5/44; C08F 36/06; C08K 5/14; C08J 3/22; C08K 2003/2296; C08K 2201/014

(57) ABSTRACT

A high wear-resistant graphene-modified natural rubber and a preparation thereof. The graphene-modified natural rubber is prepared from 100 parts by weight of a modified natural rubber blend, A parts by weight of modified graphene oxide, 35-65 parts by weight of wear-resistant carbon black, 5-20 parts by weight of a wear-resistant filler, 2-7 parts by weight of zinc oxide, 1-4 parts by weight of stearic acid, 1-4 parts by weight of poly(1,2-dihydro-2,2,4-trimethylquinoline), 1-4 parts by weight of N-isopropyl-N′-phenyl-p-phenylenediamine, 1-4 parts by weight of a vulcanization accelerator, 1-2 parts by weight of sulphur, 0.1-3 parts by weight of a compatibilizer and 1-7 parts by weight of rubber processing oil, where A is greater than 0 and equal to or less than 3.

### CROSS-REFERENCE TO RELATED APPLICATIONS

This application claims the benefit of priority from Chinese Patent Application No. 202210682912.6, filed on Jun. 16, 2022. The content of the aforementioned application, including any intervening amendments thereto, is incorporated herein by reference in its entirety.

### TECHNICAL FIELD

This application relates to wear-resistant rubber, and more particularity to a high wear-resistant graphene-modified natural rubber and a preparation thereof.

### BACKGROUND

Due to the presence of a macromolecular segment and the continuous improvement in quality, natural rubber has been widely used in the production of rubber articles such as tires, tapes and cover rubbers of conveyor belts, accounting for about 40% of the global annual rubber consumption. Moreover, rubber articles, as an indispensable part of the development of comprehensive national power, have been widely used in various fields such as medical, transportation, aerospace and military products.

Wear resistance significantly affects the service life and safety of rubber products. The improvement of wear resistance will prolong the service life, reduce the cost, and lower the resource and energy consumption. Due to the presence of fillers, a considerable amount of dust will be produced during the abrasion process, which further leads to environmental pollution and resource loss. Therefore, it is of great significance to improve the wear resistance of rubber products.

In the field of polymers, blending can reach the property complementation of each component, but it is necessary to take the compatibility between two-phase materials into consideration. In addition, with respect to the rubber blends, it is further required to consider the compatibility between the reinforcing filler and the rubber matrix. Extensive researches have been conducted on rubber blends with rigid and flexible chain segments. As the most important additive in rubber composites, the reinforcing filler has been diversified. In addition to those traditional reinforcing fillers such as carbon black and silicon dioxide, there are some novel reinforcing fillers such as carbon nanotubes and graphene, which can also improve other functions of rubber in addition to wear resistance. Whereas, these reinforcing fillers are expensive, and thus are merely used to replace the carbon black or silicon dioxide partially.

### SUMMARY

In order to improve the wear resistance of rubber products, this application provides a high wear-resistant graphene-modified natural rubber and a preparation thereof.

Technical solutions of the present disclosure are described as follows.

In a first aspect, this application provides a wear-resistant graphene-modified natural rubber, wherein the wear-resistant graphene-modified natural rubber is prepared from 100 parts by weight of a modified natural rubber blend, A parts by weight of modified graphene oxide, 35-65 parts by weight of a first wear-resistant filler, 5-20 parts by weight of a second wear-resistant filler, 2-7 parts by weight of zinc oxide, 1-4 parts by weight of stearic acid, 1-4 parts by weight of poly(1,2-dihydro-2,2,4-trimethylquinoline) (Antioxidant RD), 1-4 parts by weight of N-isopropyl-N′-phenyl-p-phenylenediamine (Antioxidant 4010NA), 1-4 parts by weight of a vulcanization accelerator, 1-2 parts by weight of sulphur, 0.1-3 parts by weight of a compatibilizer and 1-7 parts by weight of a rubber processing oil; wherein A is greater than 0 and equal to or less than 3; and the first wear-resistant filler is carbon black.

In some embodiments, the modified natural rubber blend consists of a natural rubber and a synthetic rubber in a weight ratio of (9-1):(1-2); and the synthetic rubber is selected from the group consisting of cis-polybutadiene rubber, styrene butadiene rubber, nitrile butadiene rubber, ethylene propylene diene monomer rubber, trans-1,4-poly (butadiene-co-isoprene) copolymer rubber, butyl rubber, silicone rubber, and a combination thereof.

In some embodiments, the modified graphene oxide is prepared through the steps of:
dissolving a sulfenamide vulcanization accelerator with anhydrous ethanol to obtain a sulfenamide vulcanization accelerator solution, wherein a weight ratio of the sulfenamide vulcanization accelerator to the anhydrous ethanol is 1:(0.2-0.5); mixing graphene oxide with deionized water to obtain a graphene oxide suspension, wherein a weight ratio of the graphene oxide to the deionized water is 2:(0.5-1); adding the sulfenamide vulcanization accelerator solution into the graphene oxide suspension followed by reaction at 60-80° C. under stirring for 1-3 h to obtain a reaction mixture; and subjecting the reaction mixture to vacuum filtration, washing, centrifugation and drying to obtain the modified graphene oxide.

The introduction of the modified graphene oxide will affect an internal network structure and properties of the blended rubber, as well as the vulcanization rate. The sulfenamide vulcanization accelerator-modified graphene oxide used herein not only improves the cross-linking performance of the blended rubber, but also plays a role in the vulcanization. Molecular chain segments of the modified graphene oxide grafted sulfenamide vulcanization accelerator can participate in the rubber vulcanization to shorten the vulcanization time, improve the vulcanization efficiency and enhance the cross-linking degree between rubber phases. Moreover, the lamellar structure of the modified graphene oxide contributes to the mitigation of filler agglomeration, and the improvement of filler dispersibility.

In some embodiments, the sulfenamide vulcanization accelerator is N-cyclohexyl-2-benzothiazolesulfenamide, N-(oxydiethylene)-2-benzothiazolesulfenamide (NOBS), or a combination thereof, and a weight ratio of the sulfenamide vulcanization accelerator to the graphene oxide is (5-7):1

In some embodiments, the carbon black is carbon black N110, carbon black N220, carbon black N234, carbon black N326, carbon black N330, carbon black N375, or a combination thereof.

In some embodiments, the second wear-resistant filler is selected from the group consisting of molybdenum disulfide, carbon fiber powder, carbon nanotubes, silicon dioxide, zinc oxide whiskers, fly ash, kaolin, clay, and a combination thereof.

In some embodiments, the compatibilizer is 3-aminopropyltriethoxysilane, maleic anhydride grafted polybutadiene, dicumyl peroxide, or a combination thereof.

In some embodiments, the vulcanization accelerator is N-(oxydiethylene)-2-benzothiazolesulfenamide (NOBS), tetramethyl thiuramdisulfide (TMTD), 2-mercaptobenzothiazole, N-cyclohexyl-2-benzothiazole sulfenamide (CBS), or a combination thereof.

In a second aspect, this application provides a method for preparing the wear-resistant graphene-modified natural rubber, comprising:
(S1) dispersing the modified graphene oxide in deionized water to obtain a modified graphene oxide suspension; diluting a natural rubber latex with deionized water to obtain a natural rubber latex dilution with a weight percentage of 15-25%; and adding the modified graphene oxide suspension into the natural rubber latex dilution, followed by stirring for 10-30 min, flocculation, washing and drying to obtain a masterbatch; and
(S2) mixing the masterbatch with a synthetic rubber in an internal mixer, and adding a carbon black, a rubber processing oil, zinc oxide, stearic acid, poly(1,2-dihydro-2,2,4-trimethylquinoline) (Antioxidant RD), N-isopropyl-N′-phenyl-p-phenylenediamine (Antioxidant 4010NA), a second wear-resistant filler and a compatibilizer to the internal mixer to obtain a first mixture; subjecting the first mixture, the vulcanization accelerator and sulphur to mixing by an open mill to obtain a second mixture; and subjecting the second mixture to vulcanization in a vulcanizing machine to obtain a wear-resistant graphene-modified natural rubber.

In some embodiments, a solid content of the natural rubber latex is 50-70%; a concentration of the modified graphene oxide in the modified graphene oxide suspension is 0.5-2 mg/mL; and in step (S2), the vulcanization is performed at 140-160° C. for 15-30 min.

Compared to the prior art, this application has the following beneficial effects.
(1) Regarding this application, the addition amount of the modified natural rubber blend is controlled to optimize the wear resistance of the graphene-modified natural rubber obtained. Moreover, the good compatibility between components in the rubber blend contributes to improved wear resistance and mechanical properties of the graphene-modified natural rubber.
(2) A reinforcing filler mixture including nano graphene oxide, carbon black and other wear-resistant fillers is employed herein, and through the synergistic effect of graphene oxide and other wear-resistant fillers, the wear resistance of the graphene-modified natural rubber is further improved.
(3) By means of the modification of graphene oxide with the vulcanization accelerator, the graphene aggregation is alleviated, and the interfacial interaction between the rubber matrix and graphene is enhanced, improving the filler-rubber interfacial bonding force. Particularly, the vulcanization accelerator chemically anchored on the surface of nano-fillers can not only prevent “frosting” but also improve the vulcanization rate of the natural rubber, allowing for better wear resistance and mechanical properties.

### DETAILED DESCRIPTION OF EMBODIMENTS

The present disclosure will be described in detail below with reference to the embodiments.

Unless otherwise specified, the materials used in the following embodiments are available commercially.

### Example 1

Provided herein was a natural rubber composite, which was prepared from 50 parts by weight of natural rubber, 50 parts by weight of cis-polybutadiene rubber, 65 parts by weight of carbon black N326, 3 parts by weight of dicumyl peroxide, 5 parts by weight of zinc oxide, 2 parts by weight of stearic acid, 1 part by weight of poly(1,2-dihydro-2,2,4-trimethylquinoline) (Antioxidant RD), 1 part by weight of N-isopropyl-N′-phenyl-p-phenylenediamine (Antioxidant 4010NA), 2 parts by weight of vulcanization accelerator NOBS, 2 parts by weight of sulphur and 5 parts by weight of a rubber processing oil.

The preparation was specifically performed as follows.

A natural rubber masterbatch and cis-polybutadiene rubber were mixed in an internal mixer for 5 min, to which the carbon black N326, rubber processing oil, dicumyl peroxide, zinc oxide, stearic acid, antioxidant RD, antioxidant 4010NA and vulcanization accelerator NOBS were sequentially added, and then mixed for 15 min to obtain a first mixture. The first mixture was mixed with sulphur by an open mill for 5 min to obtain a second mixture, which was subjected to vulcanization in a flat vulcanizing machine at 150° C. and 15 MPa for 15 min to obtain the natural rubber composite.

### Example 2

Provided herein was a natural rubber composite, which was prepared from 70 parts by weight of natural rubber, 30 parts by weight of styrene butadiene rubber, 1 part by weight of graphene oxide, 35 parts by weight of carbon black N220, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with styrene butadiene rubber in an internal mixer, sequentially added with the carbon black N220, rubber processing oil, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 30 min to obtain the natural rubber composite.

### Example 3

Provided herein was a natural rubber composite, which was prepared from 50 parts by weight of natural rubber, 50 parts by weight of trans-1,4-poly (butadiene-co-isoprene) copolymer rubber, 2 parts by weight of graphene oxide, 43 parts by weight of carbon black N330, 5 parts by weight of molybdenum disulfide, 2 parts by weight of maleic anhydride grafted polybutadiene, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with trans-1,4-poly (butadiene-co-isoprene) copolymer rubber in an internal mixer, sequentially added with the carbon black N330, rubber processing oil, molybdenum disulfide, maleic anhydride grafted polybutadiene, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 30 min to obtain the natural rubber composite.

### Example 4

Provided herein was a natural rubber composite, which was prepared from 70 parts by weight of natural rubber, 30 parts by weight of cis-polybutadiene rubber, 3 parts by weight of graphene oxide, 45 parts by weight of carbon black N220, 20 parts by weight of fly ash, 3 parts by weight of 3-aminopropyltriethoxysilane (KH550), 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with cis-polybutadiene rubber in an internal mixer, sequentially added with the carbon black N220, fly ash, KH550, rubber processing oil, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 20 min to obtain the natural rubber composite.

### Example 5

Provided herein was a natural rubber composite, which was prepared from 70 parts by weight of natural rubber, 30 parts by weight of styrene butadiene rubber, 3 parts by weight of graphene oxide, 43 parts by weight of carbon black N375, 5 parts by weight of zinc oxide whiskers, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with styrene butadiene rubber in an internal mixer, sequentially added with the carbon black N375, zinc oxide whiskers, rubber processing oil, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 15 min to obtain the natural rubber composite.

### Example 6

Provided herein was a natural rubber composite, which was prepared from 50 parts by weight of natural rubber, 50 parts by weight of trans-1,4-poly (butadiene-co-isoprene) copolymer rubber, 0.25 parts by weight of graphene oxide, 35 parts by weight of carbon black N326, 20 parts by weight of carbon fiber powder, 0.5 parts by weight of dicumyl peroxide, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with trans-1,4-poly (butadiene-co-isoprene) copolymer rubber in an internal mixer, sequentially added with the carbon black N326, carbon fiber powder, rubber processing oil, dicumyl peroxide, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 30 min to obtain the natural rubber composite.

### Example 7

Provided herein was a high wear-resistant graphene-modified natural rubber, which was prepared from 60 parts by weight of natural rubber, 40 parts by weight of cis-polybutadiene rubber, 3 parts by weight of modified graphene oxide, 40 parts by weight of carbon black N110, 20 parts by weight of silicon dioxide, 2 parts by weight of KH550, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

Vulcanization accelerator NOBS was dissolved with anhydrous ethanol to obtain a 1 mg/mL NOBS solution, where a weight ratio of NOBS to the anhydrous ethanol was 1:(0.2-0.5). A graphene oxide aqueous dispersion was added with the NOBS solution and reacted at 75° C. under vigorous stirring for 2 h to obtain a reaction mixture. The reaction mixture was subjected to vacuum filtration, washing, centrifugation and drying to obtain the modified graphene oxide powder. The modified graphene oxide powder was dispersed in deionized water and subjected to ultrasonication for 20 min by using an ultrasonic instrument to obtain a 1 mg/mL graphene oxide dispersion. Natural rubber latex was diluted with deionized water to obtain a natural rubber latex dilution with a weight percentage of 20%, which was added with the graphene oxide dispersion, stirred for 20 min and subjected to flocculation, washing and drying to obtain a masterbatch. The masterbatch was mixed with cis-polybutadiene rubber in an internal mixer, sequentially added with the carbon black N110, silicon dioxide, KH550, rubber processing oil, zinc oxide, stearic acid, antioxidant RD, antioxidant 4010NA and vulcanization accelerator NOBS, and then mixed in the internal mixer to obtain a first mixture. The first mixture was mixed with sulphur by an open mill to obtain a second mixture, which was subjected to vulcanization in a flat vulcanizing machine at 150° C. and 15 MPa for 20 min to obtain the high wear-resistant graphene-modified natural rubber.

### Comparative Example 1

Provided herein was a natural rubber composite, which was prepared from 100 parts by weight of natural rubber, 40 parts by weight of carbon black N110, 20 parts by weight of silicon dioxide, 2 parts by weight of KH550, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

The natural rubber was sequentially added with the carbon black N110, silicon dioxide, rubber processing oil, KH550, zinc oxide, stearic acid, antioxidant RD, antioxidant 4010NA and vulcanization accelerator NOBS, and then mixed in an internal mixer for 15 min to obtain a first mixture. The first mixture was mixed with sulphur by an open mill for 5 min to obtain a second mixture, which was subjected to vulcanization in a flat vulcanizing machine at 150° C. and 15 MPa for 20 min to obtain the natural rubber composite.

### Comparative Example 2

Provided herein was a natural rubber composite, which was prepared from 100 parts by weight of styrene butadiene rubber, 40 parts by weight of carbon black N110, 20 parts by weight of silicon dioxide, 2 parts by weight of KH550, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

The styrene butadiene rubber was sequentially added with the carbon black N110, silicon dioxide, rubber processing oil, KH550, zinc oxide, stearic acid, antioxidant RD, antioxidant 4010NA and vulcanization accelerator NOBS, and then mixed in an internal mixer for 15 min to obtain a first mixture. The first mixture was mixed with sulphur by an open mill for 5 min to obtain a second mixture. The second mixture was subjected to vulcanization in a flat vulcanizing machine at 150° C. and 15 MPa for 20 min to obtain the natural rubber composite.

### Comparative Example 3

Provided herein was a graphene modified natural rubber composite, which was prepared from 60 parts by weight of natural rubber, 40 parts by weight of cis-polybutadiene rubber, 3 parts by weight of graphene oxide, 40 parts by weight of carbon black N110, 20 parts by weight of silicon dioxide, 2 parts by weight of KH550, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with cis-polybutadiene in an internal mixer, sequentially added with the carbon black N110, silicon dioxide, KH550, rubber processing oil, zinc oxide, stearic acid, antioxidant RD, antioxidant 4010NA and vulcanization accelerator NOBS, and then mixed in the internal mixer for 15 min to obtain a first mixture. The first mixture was mixed with sulphur by an open mill for 5 min to obtain a second mixture, which was subjected to vulcanization in a flat vulcanizing machine at 150° C. and 15 MPa for 20 min to obtain the graphene modified natural rubber composite.

### Comparative Example 4

Provided herein was a graphene modified natural rubber composite, which was prepared from 60 parts by weight of natural rubber, 40 parts by weight of cis-polybutadiene rubber, 3 parts by weight of graphene oxide, 40 parts by weight of carbon black N110, 5 parts by weight of zinc oxide, 2 parts by weight of stearic acid, 1 part by weight of antioxidant RD, 1 part by weight of antioxidant 4010NA, 2 parts by weight of vulcanization accelerator NOBS, 2 parts by weight of sulphur and 5 parts by weight of rubber processing oil.

The preparation was specifically performed as follows.

A graphene oxide slurry was dispersed in deionized water and subjected to ultrasonication for 20 min by using an ultrasonic instrument to obtain a graphene oxide aqueous dispersion with a concentration of 1 mg/mL. Natural rubber latex (with a solid content of 60%) was diluted with deionized water to obtain a natural rubber latex dilution with a weight percentage of 20%. The natural rubber latex dilution was added with the graphene oxide aqueous dispersion, stirred for 20 min, and subjected to flocculation, washing and drying to obtain a masterbatch. The masterbatch was mixed with cis-polybutadiene rubber in an internal mixer, sequentially added with the carbon black N110, rubber processing oil, zinc oxide, stearic acid, antioxidant RD, antioxidant 4010NA and vulcanization accelerator NOBS, and then mixed in the internal mixer to obtain a first mixture. The first mixture was mixed with sulphur by an open mill for 5 min to obtain a second mixture, which was subjected to vulcanization in a flat vulcanizing machine at 150° C. and 15 MPa for 20 min to obtain the graphene modified natural rubber composite.

Test results of mechanical properties and wear resistance of the high wear-resistant graphene-modified natural rubber prepared in Example 7 and the natural rubber composites prepared in Comparative Examples 1-4 were shown in Table 1. It can be observed that the properties of the high wear-resistant graphene-modified natural rubber prepared in Example 7 have reached a D-level (for high wear material conveying) in Chinese government standard (GB/T 9770-2013), indicating that the natural rubber composites prepared herein have excellent mechanical properties and abrasion resistance.

TABLE 1
Test results of rubber composites of Example 7 and Comparative Examples 1-4

| | Tensile strength/MPa | | Elongation at break/% | | Abrasion/mm³ | |
|---|---|---|---|---|---|---|
| | | Government | | Government | | Government |
| Sample | Test result | standard | Test result | standard | Test result | standard |
| Example 7 | 19 | ≥18 | 453 | ≥400 | 65 | ≤100 |
| Comparative | 20 | | 450 | | 150 | |
| Example 1 | | | | | | |
| Comparative | 15 | | 350 | | 120 | |
| Example 2 | | | | | | |
| Comparative | 16 | | 450 | | 110 | |
| Example 3 | | | | | | |
| Comparative | 17 | | 440 | | 115 | |
| Example 4 | | | | | | |

What is claimed is:

1. A wear-resistant graphene-modified natural rubber, wherein the wear-resistant graphene-modified natural rubber is prepared from 100 parts by weight of a modified natural rubber blend, A parts by weight of modified graphene oxide, 35-65 parts by weight of a first wear-resistant filler, 5-20 parts by weight of a second wear-resistant filler, 2-7 parts by weight of zinc oxide, 1-4 parts by weight of stearic acid, 1-4 parts by weight of poly(1,2-dihydro-2,2,4-trimethylquinoline) (antioxidant RD), 1-4 parts by weight of N-isopropyl-N′-phenyl-p-phenylenediamine (antioxidant 4010NA), 1-4 parts by weight of a vulcanization accelerator, 1-2 parts by weight of sulphur, 0.1-3 parts by weight of a compatibilizer and 1-7 parts by weight of a rubber processing oil; wherein A is greater than 0 and equal to or less than 3; and the first wear-resistant filler is carbon black.

2. The wear-resistant graphene-modified natural rubber of claim 1, wherein the modified natural rubber blend consists of a natural rubber and a synthetic rubber in a weight ratio of (9-1):(1-2); and the synthetic rubber is selected from the group consisting of cis-polybutadiene rubber, styrene butadiene rubber, nitrile butadiene rubber, ethylene propylene diene monomer rubber, trans-1,4-poly (butadiene-co-isoprene) copolymer rubber, butyl rubber, silicone rubber and a combination thereof.

3. The wear-resistant graphene-modified natural rubber of claim 1, wherein the modified graphene oxide is prepared through steps of:
dissolving a sulfenamide vulcanization accelerator with anhydrous ethanol to obtain a sulfenamide vulcanization accelerator solution, wherein a weight ratio of the sulfenamide vulcanization accelerator to the anhydrous ethanol is 1:(0.2-0.5); mixing graphene oxide with deionized water to obtain a graphene oxide suspension, wherein a weight ratio of the graphene oxide to the deionized water is 2:(0.5-1); adding the sulfenamide vulcanization accelerator solution into the graphene oxide suspension followed by reaction at 60-80° C. under stirring for 1-3 h to obtain a reaction mixture; and subjecting the reaction mixture to vacuum filtration, washing, centrifugation and drying to obtain the modified graphene oxide.

4. The wear-resistant graphene-modified natural rubber of claim 3, wherein the sulfenamide vulcanization accelerator is N-cyclohexyl-2-benzothiazolesulfenamide, N-(oxydiethylene)-2-benzothiazolesulfenamide (NOBS), or a combination thereof; and a weight ratio of the sulfenamide vulcanization accelerator to the graphene oxide is (5-7):1

5. The wear-resistant graphene-modified natural rubber of claim 1, wherein the carbon black is carbon black N110, carbon black N220, carbon black N234, carbon black N326, carbon black N330, carbon black N375, or a combination thereof.

6. The wear-resistant graphene-modified natural rubber of claim 1, wherein the second wear-resistant filler is selected from the group consisting of molybdenum disulfide, carbon fiber powder, carbon nanotubes, silicon dioxide, zinc oxide whiskers, fly ash, kaolin, clay, and a combination thereof.

7. The wear-resistant graphene-modified natural rubber of claim 1, wherein the compatibilizer is 3-aminopropyltriethoxysilane, maleic anhydride grafted polybutadiene, dicumyl peroxide, or a combination thereof.

8. The wear-resistant graphene-modified natural rubber of claim 1, wherein the vulcanization accelerator is N-(oxydiethylene)-2-benzothiazolesulfenamide (NOBS), tetramethyl thiuramdisulfide (TMTD), 2-mercaptobenzothiazole, N-cyclohexyl-2-benzothiazole sulfenamide (CBS), or a combination thereof.

9. A method for preparing the wear-resistant graphene-modified natural rubber of claim 1, comprising:
(S1) dispersing the modified graphene oxide in deionized water to obtain a modified graphene oxide suspension; diluting a natural rubber latex with deionized water to obtain a natural rubber latex dilution with a weight percentage of 15-25%; and adding the modified graphene oxide suspension into the natural rubber latex dilution, followed by stirring for 10-30 min, flocculation, washing and drying to obtain a masterbatch; and
(S2) mixing the masterbatch with a synthetic rubber in an internal mixer, and adding a carbon black, a rubber processing oil, zinc oxide, stearic acid, poly(1,2-dihydro-2,2,4-trimethylquinoline) (RD), N-isopropyl-N′-phenyl-p-phenylenediamine (4010NA), vulcanization accelerator, a second wear-resistant filler and a compatibilizer to the internal mixer to obtain a first mixture; subjecting the first mixture and sulphur to mixing by an open mill to obtain a second mixture; and subjecting the second mixture to vulcanization in a vulcanizing machine to obtain the wear-resistant graphene-modified natural rubber.

10. The method of claim 9, wherein a solid content of the natural rubber latex is 50-70%; a concentration of the modified graphene oxide in the modified graphene oxide suspension is 0.5-2 mg/mL; and in step (S2), the vulcanization is performed at 140-160° C. for 15-30 min.
